(19) United States
(12) Patent Application Publication
(10) Pub. No.: US 2009/0216422 A1
(43) Pub. Date: Aug. 27, 2009

(54) Electronic Fuel Injection Controller

(76) Inventor: George Wesley Burch, Lynn Haven, FL (US)

Correspondence Address: Wes Burch, 1606 Maryland Ave, Lynn Haven, FL, 32444, US

(21) Appl. No.: 12/037,910

(22) Filed: Feb. 26, 2008

(51) Int. Cl. F02D 41/30

(52) U.S. Cl. 701/103

(57) ABSTRACT

The fuel injection controller is an electronic device for the “Generation I” Chevrolet V8 engine. The fuel injection controller measures rotational position and rotational speed for both the crankshaft and the camshaft. The uniqueness of this design is that it repackages the internal components from a standard front-mount location “Optispark” distributor normally found on a “Generation II” Chevrolet engine into a housing that mounts the components internally in a top rear-mount location on “Generation I” Chevrolet engines. The fuel injection controller then allows use of a standard production Chevrolet “Generation II” fuel injection computer (not a part of this patent) for a “Generation I” Chevrolet fuel injected engine. Because of insufficient information for rotational position and rotational speed for both the crankshaft and the camshaft, “Generation I” Chevrolet engine fuel injection computers were restricted to operate in “batch fire”. Batch fire means all the injectors on one bank of a V8 fire, then all the injectors on the other bank fire, etc. This fuel injection controller and associated Chevrolet “Generation II” fuel injection computer (not a part of this patent) allows sequential control of the fuel injectors on a “Generation I” Chevrolet fuel injected engine so that each injector fires only when the intake valve is opening. The fuel injection controller and associated Chevrolet “Generation II” fuel injection computer also allow electronic “flash” programming of engine control parameters where previous “Generation I” Chevrolet fuel injection computers required reprogramming via changing a replaceable EPROM.

### FIELD OF THE INVENTION

This invention relates to the method used by an automobile engine fuel injection computer to measure rotational position and rotational speed for both the crankshaft and the camshaft. Related applications would include (class/subclass): 123/406.11, 406.12, 406.58, 406.59, 406.6, 406.61, 406.63, 472, 474, & 475.

### BACKGROUND OF THE INVENTION

The “Generation I” Chevrolet engine began production in 1955 and continued well into the 1990s. The top-rear mounted “Generation I” Chevrolet engine distributor only measured crankshaft position and camshaft position accurately enough to enable the timing of ignition pulses. Mechanical means were then used to direct the ignition pulse to the appropriate cylinder. Without sufficient rotational position and rotational speed for both the crankshaft and the camshaft, “Generation I” Chevrolet fuel injection computers could only operate in batch fire which means all the fuel injectors on one bank of a V8 fire, then all the injectors on the other bank fire, etc. This non-optimized method results in dwell time while the atomized fuel charge waits in the intake port for an intake valve to open. The dwell time allows the vaporized fuel to condense into larger droplets which do not burn as quickly once the droplets move into the engine's combustion chamber.

“Generation I” Chevrolet fuel injection computers retain all the engine control parameters in a UV erasable, replaceable EPROM. Thus changes to engine control parameters requires a change of the UV erasable EPROM.

“Generation II” Chevrolet engines produced between 1991 and 1996 use a front-mount “Optispark distributor” to measure rotational position and rotational speed for both the crankshaft and the camshaft. The electronic signals created by the “Optispark” distributor enable use of the associated “Generation II” fuel injection computer which will precisely control sequential fuel injector pulses (timed to coincide with intake valve opening) as well as very precisely controlled ignition pulses.

The “Generation II” Chevrolet engine fuel injection computer allows “flash” programming of engine control parameters found in the computer's Electrically Erasable PROM (EEPROM).

The “Generation II” Chevrolet Optispark distributor cannot be mounted on any other Chevrolet (nor other) engine without significant investment in water pump redesign, timing chain redesign, timing chain cover redesign, and camshaft design modification. The fuel injection controller described herein repackages front-mount Optispark distributor internal components into a new rear-top mount housing. The fuel injection controller can then be installed in all “Generation I” Chevrolet fuel injected engines without further modification to the engine. The fuel injection controller can then measure Chevrolet “Generation I” engine rotational position and rotational speed for both the crankshaft and the camshaft. The design enables use of the associated “Generation II” fuel injection computer on “Generation I” Chevrolet fuel injected engines. On “Generation I” Chevrolet fuel injected engines this allows: Precisely controlled sequential fuel injector pulses (timed to coincide with intake valve opening). Precisely controlled ignition pulses. Flash programmable engine control parameters. This new design represents an application base estimated greatly in excess of 100 million engines.

### SUMMARY OF THE INVENTION

The fuel injection controller enables use of a “Generation II” Chevrolet fuel injection computer on “Generation I” Chevrolet fuel injection engines. The fuel injection controller is similar in operation (but neither appearance, nor mounting, nor location, nor drive mechanism) to the Chevrolet “Optispark” distributor used in the “Generation II” Chevrolet engine.

The principal objective of this fuel injection controller is that it enables use of the “Generation II” Chevrolet fuel injection computer (not part of this patent) on “Generation I” Chevrolet fuel injected engines. Previously, “Generation I” Chevrolet fuel injected engines could only operate with “Generation I” Chevrolet fuel injection computers.

The secondary objective of this fuel injection controller and associated “Generation II” Chevrolet fuel injection computer (not part of this patent) is to enable optimized and precise sequential fuel injection in older “Generation I” fuel injected engines. Previously, “Generation I” Chevrolet fuel injected engines could only operate in “batch fire” fuel injection.

The third objective of the fuel injection controller is that by enabling use of the “Generation II” Chevrolet fuel injection computer (not part of this patent) “flash” programming of engine control parameters is available for “Generation I” Chevrolet fuel injected engines. Previously, reprogramming “Generation I” Chevrolet fuel injection computers required changing a replaceable EPROM.

### BRIEF DESCRIPTION OF THE DRAWING

FIG. 1 is a side view of the fuel injection controller according to this specification;

FIG. 2 is a section of the fuel injection controller showing mounting for both the dual path shutter and dual optical transmitter as well as the dual path shutter wheel drive mechanism;

FIG. 3 is a top view of the fuel injection controller showing the dual path shutter wheel and dual optical transmitter;

FIG. 4 is a detail drawing of the dual path shutter wheel.

### EMBODYMENT OF THE INVENTION

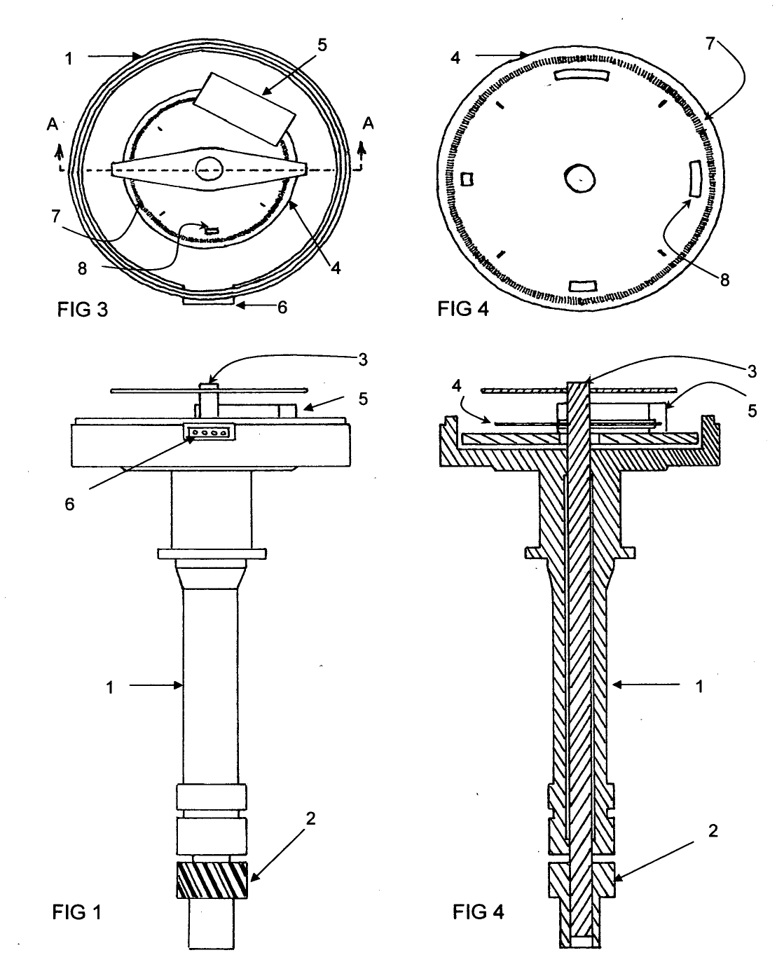

Referring to the drawing, FIG. 1, the fuel injection controller housing 1 mounts in a “Generation I” Chevrolet engine in the traditional top rear mounting location of the engine's conventional distributor. Like the conventional distributor, the fuel injection controller has a helical gear 2 at its base that meshes with the engine's camshaft. Thus the FIG. 2 fuel injection controller main shaft 3 rotates at exact camshaft rotation speed (and one half of crankshaft rotation). The fuel injection controller housing also contains the round disc dual path shutter wheel 4 and dual optical transmitter 5. In this manner the dual path shutter wheel, which is firmly fixed to the fuel injection controller main shaft, also spins at camshaft speed.

The fuel injection controller dual optical transmitter is switched on when it receives 12 volts from the engine's fuel injection computer through its electrical connector 6. (The fuel injection computer is not part of this claim.)

In FIG. 3, the dual path shutter wheel passes through a slot in the fixed dual optical transmitter. So, as the engine's camshaft rotates and drives the fuel injection controller main shaft, the shutter wheel rotates and presents a series of encoded slots in the shutter wheel to the dual optical transmitter. The dual optical transmitter light path is interrupted by slots in the shutter wheel.

FIG. 4 reveals the design of the shutter wheel. The shutter wheel has two circular, concentric slot-rows rows. As each slot passes through the dual optical transmitter, a voltage pulse is sent to the fuel injection computer. The outer slot-row 7 contains 360 slots of uniform width. Since the shutter wheel rotates at exactly one half of crankshaft RPM, the high resolution pulses sent from the fuel injection controller to the fuel injection computer allow the fuel injection computer to update crankshaft rotation speed every two degrees of rotation. The inner slot row 8 contains four slots of varying widths mixed with four slots of narrow width (pulse width modulation). Because the outer slot-row on the shutter wheel has already provided high resolution angular rotation speed information, the electronic fuel injection computer can then calculate the anticipated pulse width for the low resolution inner row of camshaft position slots. When the fuel injection computer receives a matching digitally encoded pulse from the fuel injection controller of the correct width, it “knows” the exact location of both the crankshaft and camshaft.

In this manner, the fuel injection controller controls the fuel injection computer's ability to provide exact sequential engine fuel injector firing signals and ignition pulses.

1. The fuel injection controller is unique in utility because its different packaging, different mounting position, and different drive mechanism make it applicable to the significantly broader range of “Generation I” Chevrolet engines than the “Generation II” Chevrolet engine “Optispark” distributor design allows.

2. The fuel injection controller relocates the crankshaft location and camshaft location sensor required for sequential fuel injection from the front of the engine (as in “Generation II” Chevrolet engines) to the top rear of the engine (as in “Generation I” Chevrolet engines).

3. The top rear engine mounting location of this fuel injection controller makes the device much less susceptible to damage from water intrusion, oil intrusion, and road debris than the Chevrolet “Optispark” distributor front mount position provides.

4. The fuel injection controller design integrates into the “Generation I” Chevrolet engine without modification to the automobile engine architecture.

5. Only because the fuel injection controller provides rotational position and rotational speed for both the crankshaft and the camshaft can the “generation II” Chevrolet fuel injection computer be used to allow sequential fuel injection on “Generation I” fuel injected engines.

6. Only because the fuel injection controller enables use of the “Generation II” fuel injection computer which allows “flash” reprogramming, can a “Generation I” Chevrolet fuel injected engine equipped with a “Generation II” fuel injection computer can be “flash programmed.
